(19) United States
(12) Patent Application Publication
(10) Pub. No.: US 2018/0004215 A1
(43) Pub. Date: Jan. 4, 2018

(54) PATH PLANNING OF AN AUTONOMOUS VEHICLE FOR KEEP CLEAR ZONES

(71) Applicant: GM GLOBAL TECHNOLOGY OPERATIONS LLC, Detroit, MI (US)

(72) Inventors: Nicholas Miller, San Francisco, CA (US); Drew Gross, San Francisco, CA (US); Shiva Ghose, Berkeley, CA (US)

(73) Assignee: GM GLOBAL TECHNOLOGY OPERATIONS LLC, Detroit, MI (US)

(21) Appl. No.: 15/706,205

(22) Filed: Sep. 15, 2017

(51) Int. Cl. G05D 1/02; G05D 1/00

(52) U.S. Cl. CPC G05D 1/0214; G05D 1/0088; G05D 2201/0213

(57) ABSTRACT

Systems and method are provided for controlling a vehicle. In one embodiment, a method includes: identifying, by a processor, at least one keep clear zone having a beginning and an ending within a roadway; determining, by a processor, if a speed of the vehicle is expected to be below a threshold when a position of the vehicle is expected to be within the keep clear zone; creating, by a processor, a stop point associated with the keep clear zone based on the determining; generating, by a processor, advice to a path planner based on the stop point; generating, by a processor, a path plan based on the stop point; and controlling, by a processor, the vehicle based on the path plan.

### INTRODUCTION

The present disclosure generally relates to autonomous vehicles, and more particularly relates to systems and methods for controlling a vehicle when encountering an area along a roadway in which a vehicle should not stop.

An autonomous vehicle is a vehicle that is capable of sensing its environment and navigating with little or no user input. An autonomous vehicle senses its environment using sensing devices such as radar, lidar, image sensors, and the like. The autonomous vehicle system further uses information from global positioning systems (GPS) technology, navigation systems, vehicle-to-vehicle communication, vehicle-to-infrastructure technology, and/or drive-by-wire systems to navigate the vehicle.

Vehicle automation has been categorized into numerical levels ranging from Zero, corresponding to no automation with full human control, to Five, corresponding to full automation with no human control. Various automated driver-assistance systems, such as cruise control, adaptive cruise control, and parking assistance systems correspond to lower automation levels, while true “driverless” vehicles correspond to higher automation levels.

While autonomous vehicles and semi-autonomous vehicles offer many potential advantages over traditional vehicles, in certain circumstances it may be desirable for improved operation of the vehicles. For example, in certain instances a path planner of the autonomous vehicle may plan a stop of the vehicle in an area where stops should be avoided (e.g., an intersection, a cross walk, railroad tracks, no parking zone, etc.) for legal and/or safety reasons. Accordingly, it is desirable to provide systems and methods that identify these areas as keep clear zones (i.e., areas where stops should be avoided) when planning the path of the vehicle. It is further desirable to provide a plan for an alternate stop or path when a keep clear zone is identified. Furthermore, other desirable features and characteristics of the present invention will become apparent from the subsequent detailed description and the appended claims, taken in conjunction with the accompanying drawings and the foregoing technical field and background.

### SUMMARY

Systems and method are provided for controlling a vehicle. In one embodiment, a method includes: identifying, by a processor, at least one keep clear zone having a beginning and an ending within a roadway; determining, by a processor, if a speed of the vehicle is expected to be below a threshold when a position of the vehicle is expected to be within the keep clear zone; creating, by a processor, a stop point associated with the keep clear zone based on the determining; generating, by a processor, advice to a path planner based on the stop point; generating, by a processor, a path plan based on the stop point; and controlling, by a processor, the vehicle based on the path plan.

In one embodiment, a system includes: a first non-transitory module configured to, by a processor, identify at least one keep clear zone having a beginning and an ending within a roadway. The system further includes a second non-transitory module configured to, by a processor, determine if a speed of the vehicle is expected to be below a threshold when a position of the vehicle is expected to be within the keep clear zone, and selectively create a stop point associated with the keep clear zone based on the determining. The system further includes a third non-transitory module configured to, by a processor, generate advice to a path planner based on the stop point, wherein the vehicle is controlled based on the advice.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram illustrating an autonomous vehicle having a path planning system, in accordance with various embodiments;

FIG. 2 is a functional block diagram illustrating a transportation system having one or more autonomous vehicles of FIG. 1, in accordance with various embodiments;

FIGS. 3 and 4 are dataflow diagrams illustrating an autonomous driving system that includes the path planning system of the autonomous vehicle, in accordance with various embodiments; and

FIG. 5 is a flowchart illustrating a control method for controlling the autonomous vehicle, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

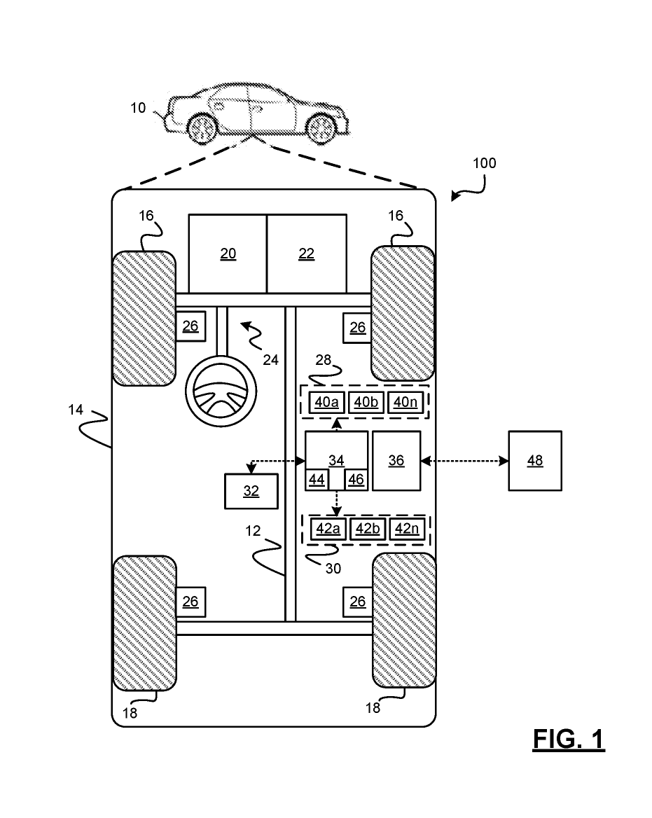

With reference to FIG. 1, a path planning system shown generally at 100 is associated with a vehicle 10 in accordance with various embodiments. In general, the path planning system 100 receives and processes sensor data and/or map data to determine whether an area in an upcoming path includes a keep clear zone. As used herein, a keep clear zone is an area of the roadway that the vehicle 10 should not stop in, such as, but not limited to, an intersection, railroad tracks, a cross walk, etc. When a keep clear zone is identified in the upcoming path, the path planning system 100 seeks advice from a motion planner on whether the vehicle 10 could be stopped outside of the keep clear zone. In various embodiments, the motion planner ignores traditionally planned stop points that are based on tracked objects and other roadway features when generating the advice. The path planning system 100 plans a final path plan for the vehicle 10 to follow based on the advice.

As depicted in FIG. 1, the exemplary vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

In various embodiments, the vehicle 10 is an autonomous vehicle and the path planning system 100 described herein is incorporated into the autonomous vehicle (hereinafter referred to as the autonomous vehicle 10). The autonomous vehicle 10 is, for example, a vehicle that is automatically controlled to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used. In an exemplary embodiment, the autonomous vehicle 10 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

As shown, the autonomous vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16-18 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 16-18. The brake system 26 may, in various embodiments, include friction brakes, brake by wire, a regenerative braking system such as an electric machine, and/or other appropriate braking systems. The steering system 24 influences a position of the of the vehicle wheels 16-18. While depicted as including a steering wheel for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras, thermal cameras, ultrasonic sensors, inertial measurement units, and/or other sensors. The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but are not limited to, doors, a trunk, and cabin features such as air, music, lighting, etc. (not numbered).

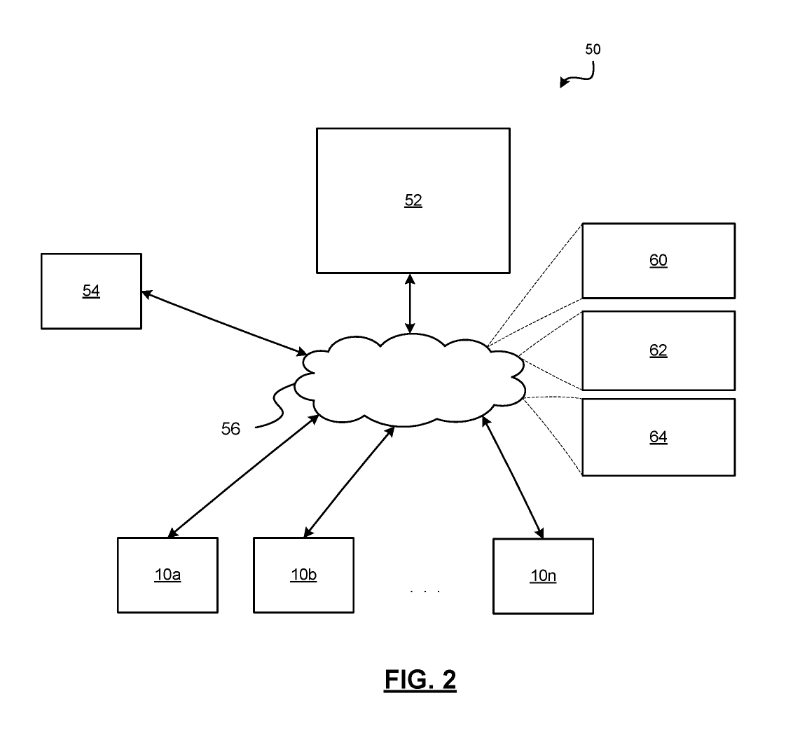

The communication system 36 is configured to wirelessly communicate information to and from other entities 48, such as but not limited to, other vehicles (“V2V” communication,) infrastructure (“V2I” communication), remote systems, and/or personal devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The data storage device 32 stores data for use in automatically controlling the autonomous vehicle 10. In various embodiments, the data storage device 32 stores defined maps of the navigable environment. In various embodiments, the defined maps may be predefined by and obtained from a remote system (described in further detail with regard to FIG. 2). For example, the defined maps may be assembled by the remote system and communicated to the autonomous vehicle 10 (wirelessly and/or in a wired manner) and stored in the data storage device 32. Route information may also be stored within data storage device 32—i.e., a set of road segments (associated geographically with one or more of the defined maps) that together define a route that the user may take to travel from a start location (e.g., the user's current location) to a target location. As can be appreciated, the data storage device 32 may be part of the controller 34, separate from the controller 34, or part of the controller 34 and part of a separate system.

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10. In various embodiments, the controller 34 is configured to implement the path planning systems and methods as discussed in detail below.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals to the actuator system 30 to automatically control the components of the autonomous vehicle 10 based on the logic, calculations, methods, and/or algorithms. Although only one controller 34 is shown in FIG. 1, embodiments of the autonomous vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10.

In various embodiments, one or more instructions of the controller 34 are embodied in the path planning system 100 and, when executed by the processor 44, process sensor data and/or map data, identify keep clear zones within an upcoming path, generate advice as to whether the vehicle 10 can be stopped outside of keep clear zone, and plan the path of the vehicle 10 based on the advice.

With reference now to FIG. 2, in various embodiments, the autonomous vehicle 10 described with regard to FIG. 1 may be suitable for use in the context of a taxi or shuttle system in a certain geographical area (e.g., a city, a school or business campus, a shopping center, an amusement park, an event center, or the like) or may simply be managed by a remote system. For example, the autonomous vehicle 10 may be associated with an autonomous vehicle based remote transportation system. FIG. 2 illustrates an exemplary embodiment of an operating environment shown generally at 50 that includes an autonomous vehicle based remote transportation system 52 that is associated with one or more autonomous vehicles 10a-10n as described with regard to FIG. 1. In various embodiments, the operating environment 50 further includes one or more user devices 54 that communicate with the autonomous vehicle 10 and/or the remote transportation system 52 via a communication network 56.

The communication network 56 supports communication as needed between devices, systems, and components supported by the operating environment 50 (e.g., via tangible communication links and/or wireless communication links). For example, the communication network 56 can include a wireless carrier system 60 such as a cellular telephone system that includes a plurality of cell towers (not shown), one or more mobile switching centers (MSCs) (not shown), as well as any other networking components required to connect the wireless carrier system 60 with a land communications system. Each cell tower includes sending and receiving antennas and a base station, with the base stations from different cell towers being connected to the MSC either directly or via intermediary equipment such as a base station controller. The wireless carrier system 60 can implement any suitable communications technology, including for example, digital technologies such as CDMA (e.g., CDMA2000), LTE (e.g., 4G LTE or 5G LTE), GSM/GPRS, or other current or emerging wireless technologies. Other cell tower/base station/MSC arrangements are possible and could be used with the wireless carrier system 60. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from including the wireless carrier system 60, a second wireless carrier system in the form of a satellite communication system 64 can be included to provide uni-directional or bi-directional communication with the autonomous vehicles 10a-10n. This can be done using one or more communication satellites (not shown) and an uplink transmitting station (not shown). Uni-directional communication can include, for example, satellite radio services, wherein programming content (news, music, etc.) is received by the transmitting station, packaged for upload, and then sent to the satellite, which broadcasts the programming to subscribers. Bi-directional communication can include, for example, satellite telephony services using the satellite to relay telephone communications between the vehicle 10 and the station. The satellite telephony can be utilized either in addition to or in lieu of the wireless carrier system 60.

A land communication system 62 may further be included that is a conventional land-based telecommunications network connected to one or more landline telephones and connects the wireless carrier system 60 to the remote transportation system 52. For example, the land communication system 62 may include a public switched telephone network (PSTN) such as that used to provide hardwired telephony, packet-switched data communications, and the Internet infrastructure. One or more segments of the land communication system 62 can be implemented through the use of a standard wired network, a fiber or other optical network, a cable network, power lines, other wireless networks such as wireless local area networks (WLANs), or networks providing broadband wireless access (BWA), or any combination thereof. Furthermore, the remote transportation system 52 need not be connected via the land communication system 62, but can include wireless telephony equipment so that it can communicate directly with a wireless network, such as the wireless carrier system 60.

Although only one user device 54 is shown in FIG. 2, embodiments of the operating environment 50 can support any number of user devices 54, including multiple user devices 54 owned, operated, or otherwise used by one person. Each user device 54 supported by the operating environment 50 may be implemented using any suitable hardware platform. In this regard, the user device 54 can be realized in any common form factor including, but not limited to: a desktop computer; a mobile computer (e.g., a tablet computer, a laptop computer, or a netbook computer); a smartphone; a video game device; a digital media player; a piece of home entertainment equipment; a digital camera or video camera; a wearable computing device (e.g., smart watch, smart glasses, smart clothing); or the like. Each user device 54 supported by the operating environment 50 is realized as a computer-implemented or computer-based device having the hardware, software, firmware, and/or processing logic needed to carry out the various techniques and methodologies described herein. For example, the user device 54 includes a microprocessor in the form of a programmable device that includes one or more instructions stored in an internal memory structure and applied to receive binary input to create binary output. In some embodiments, the user device 54 includes a GPS module capable of receiving GPS satellite signals and generating GPS coordinates based on those signals. In other embodiments, the user device 54 includes cellular communications functionality such that the device carries out voice and/or data communications over the communication network 56 using one or more cellular communications protocols, as are discussed herein. In various embodiments, the user device 54 includes a visual display, such as a touch-screen graphical display, or other display.

The remote transportation system 52 includes one or more backend server systems, which may be cloud-based, network-based, or resident at the particular campus or geographical location serviced by the remote transportation system 52. The remote transportation system 52 can be manned by a live advisor, or an automated advisor, or a combination of both. The remote transportation system 52 can communicate with the user devices 54 and the autonomous vehicles 10a-10n to schedule rides, dispatch autonomous vehicles 10a-10n, and the like. In various embodiments, the remote transportation system 52 stores account information such as subscriber authentication information, vehicle identifiers, profile records, behavioral patterns, and other pertinent subscriber information.

In accordance with a typical use case workflow, a registered user of the remote transportation system 52 can create a ride request via the user device 54. The ride request will typically indicate the passenger's desired pickup location (or current GPS location), the desired destination location (which may identify a predefined vehicle stop and/or a user-specified passenger destination), and a pickup time. The remote transportation system 52 receives the ride request, processes the request, and dispatches a selected one of the autonomous vehicles 10a-10n (when and if one is available) to pick up the passenger at the designated pickup location and at the appropriate time. The remote transportation system 52 can also generate and send a suitably configured confirmation message or notification to the user device 54, to let the passenger know that a vehicle is on the way.

As can be appreciated, the subject matter disclosed herein provides certain enhanced features and functionality to what may be considered as a standard or baseline autonomous vehicle 10 and/or an autonomous vehicle based remote transportation system 52. To this end, an autonomous vehicle and autonomous vehicle based remote transportation system can be modified, enhanced, or otherwise supplemented to provide the additional features described in more detail below.

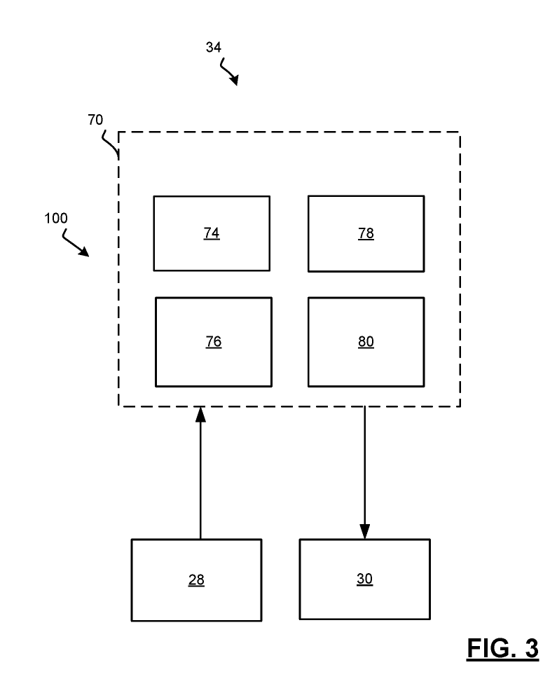

In accordance with various embodiments, the controller 34 implements an autonomous driving system (ADS) 70 as shown in FIG. 3. That is, suitable software and/or hardware components of the controller 34 (e.g., the processor 44 and the computer-readable storage device 46) are utilized to provide an autonomous driving system 70 that is used in conjunction with vehicle 10.

In various embodiments, the instructions of the autonomous driving system 70 may be organized by function, module, or system. For example, as shown in FIG. 3, the autonomous driving system 70 can include a computer vision system 74, a positioning system 76, a guidance system 78, and a vehicle control system 80. As can be appreciated, in various embodiments, the instructions may be organized into any number of systems (e.g., combined, further partitioned, etc.) as the disclosure is not limited to the present examples.

In various embodiments, the computer vision system 74 synthesizes and processes sensor data and predicts the presence, location, classification, and/or path of objects and features of the environment of the vehicle 10. In various embodiments, the computer vision system 74 can incorporate information from multiple sensors, including but not limited to cameras, lidars, radars, and/or any number of other types of sensors.

The positioning system 76 processes sensor data along with other data to determine a position (e.g., a local position relative to a map, an exact position relative to lane of a road, vehicle heading, velocity, etc.) of the vehicle 10 relative to the environment. The guidance system 78 processes sensor data along with other data to determine a path for the vehicle 10 to follow. The vehicle control system 80 generates control signals for controlling the vehicle 10 according to the determined path.

In various embodiments, the controller 34 implements machine learning techniques to assist the functionality of the controller 34, such as feature detection/classification, obstruction mitigation, route traversal, mapping, sensor integration, ground-truth determination, and the like.

As mentioned briefly above, the path planning system 100 of FIG. 1 is included within the ADS 70, for example, as part of the guidance system 78. In particular, the path planning system 100 receives information from the computer vision system 74, and the positioning system 76, and determines a path for the vehicle to follow along a route. In various embodiments, the path planning system 100 evaluates an upcoming path for keep clear zones and takes into account advisements of stop points from a motion planner.

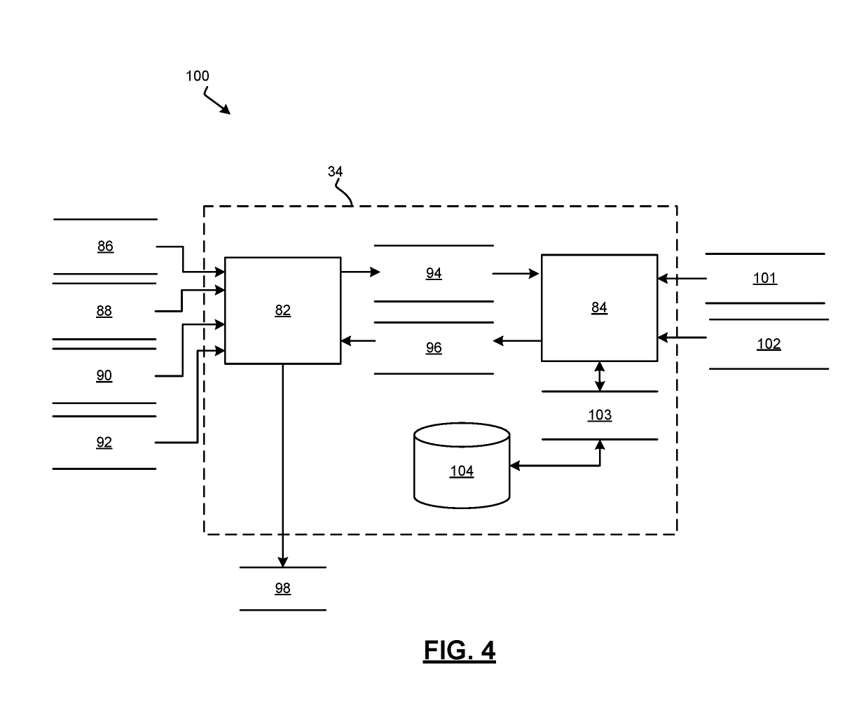

For example, as shown in more detail with regard to FIG. 4 and with continued reference to FIG. 3, the path planning system 100 includes a path planner module 82 and a motion planner module 84. The path planner module 82 processes object information 86 (including the presence of and predicted trajectories of objects), localization information 88, map information 90, and a desired vehicle route 92 to determine a upcoming path 98 to be followed to maintain the vehicle 10 on the desired route. The path planner module 82 plans the path 98 while obeying traffic laws and avoiding any detected obstacles. For example, the path planner module 82 employs algorithms configured to avoid any detected obstacles in the vicinity of the vehicle 10, maintain the vehicle 10 in a current traffic lane, and maintain the vehicle 10 on the desired route.

In various embodiments the upcoming path 98 includes a plan of lanes 94 for the vehicle to travel in along the upcoming path 98. In various embodiments, the path planner module 82 plans a final path 98 based on the upcoming path and while taking into account advice 96 from the motion planner module 84. For example, the advice 96 takes into account keep clear zones with the lane and selectively indicates stop points along the planned path 98. The path planner module 82 processes the advice 96 along with other information (e.g., other stop points from other motion planners) to determine whether the stop points can be achieved when finalizing the vehicle path 98.

The motion planner module 84 processes current vehicle motion information to determine the advice 96 for the path planner module 82. For example the motion planner module 84 queries a current speed 101 and current position 102 of the vehicle 10 and forecasts future speeds and positions (e.g., within the next 12 seconds, or other future time) of the vehicle 10 based on the current speed 101 and current position 102 and without taking into other stop points created by other motion planners for stopping. As can be appreciated, other vehicle values such as acceleration/deceleration can be taken into account when forecasting the vehicle speed and/or position as the disclosure is not limited to the present examples.

Based on the forecasts, the motion planner module 84 determines if a stop (and/or speed below a threshold) is expected to occur in a keep clear zone (or at an end of a keep clear zone). In various embodiments, the keep clear zones can be predefined, for example, based on a location and known road features associated with the location, and stored in a semantic map 104 of keep clear zones 103. In such case, the keep clear zone 103 is retrieved from the semantic map 104 based on the location identified by the lanes of the lane plan 94. Alternatively or additionally, the keep clear zone 103 can be retrieved based on identified lane features of the upcoming lane of the lane plane 94. As can be appreciated, the keep clear zones can be identified by other means, such as, for example realtime image processing, using machine learning techniques, or other techniques as the disclosure is not limited to the present examples.

When it is determined that a stop (and/or speed below a threshold) is expected to occur in a keep clear zone 103 (or at an end of a keep clear zone 103), the motion planner module 84 determines if it is possible to stop the vehicle 10 outside of the keep clear zone 103 based on the current speed 101 and current position 102. While the motion planner module 84 may determine that it may be possible to bring the vehicle 10 to a stop, the motion planner module 84 may further take into account, in various embodiments, vehicle data such as jerk values, acceleration values, and/or deceleration values when determining if it is possible, so as to determine if the stop would be a “comfortable stop.” If it is possible to “comfortably” stop the vehicle 10, the motion planner module 84 creates a stop point and generates the advice 96 including the stop point.

In various embodiments, the motion planner module 84 manages the timing of the stop point such that vehicle jerk is minimized (e.g., by applying a low-pass filter, or other means to a keep clear signal associated with the advice). In various embodiments, the motion planner module 84 manages the timing of the stop point to eliminate flickering (e.g., stop/don't stop) due to transient sensor and/or prediction data (e.g., by applying one or more hysteresis).

It will be understood that various embodiments of path planning system 100 according to the present disclosure may include any number of additional sub-modules embedded within the controller 34 which may be combined and/or further partitioned to similarly implement systems and methods described herein. Furthermore, inputs to the path planning system 100 may be received from the sensor system 28, received from other control modules (not shown) associated with the autonomous vehicle 10, received from the communication system 36, and/or determined/modeled by other sub-modules (not shown) within the controller 34 of FIG. 1. Furthermore, the inputs might also be subjected to preprocessing, such as sub-sampling, noise-reduction, normalization, feature-extraction, missing data reduction, and the like.

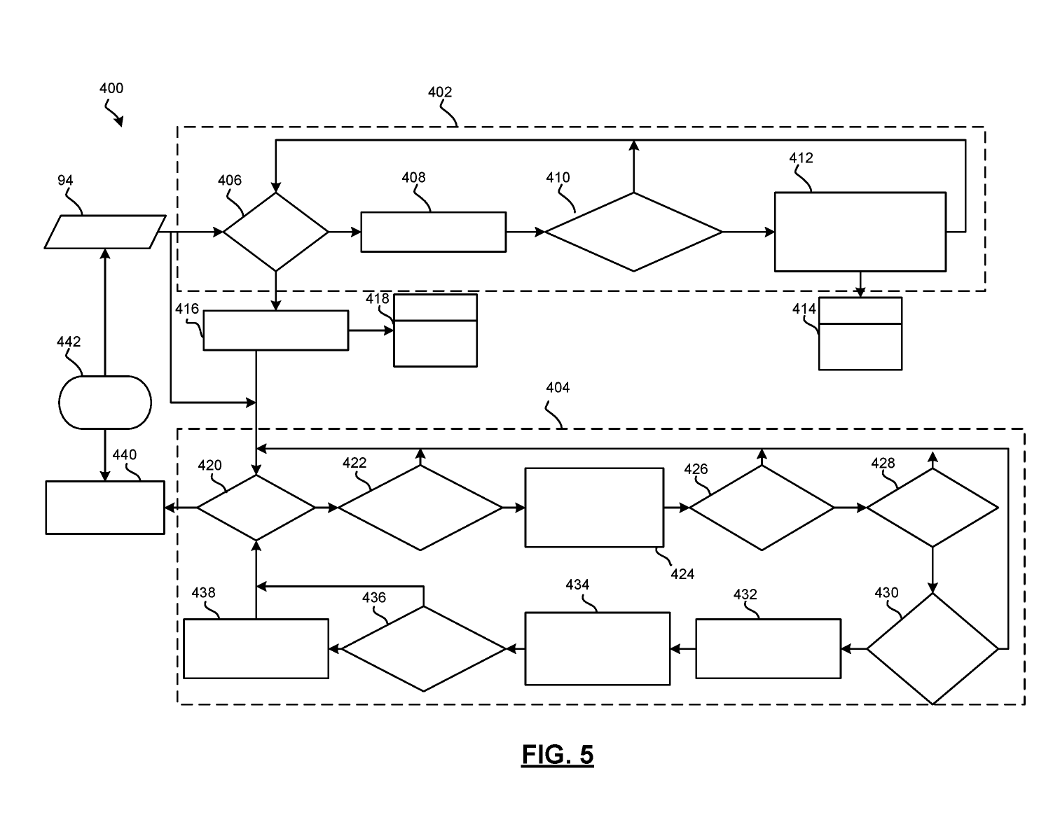

Referring now to FIG. 5, and with continued reference to FIGS. 1-4, a flowchart illustrates a control method 400 that can be performed by the path planning system 100 of FIG. 1 in accordance with the present disclosure. As can be appreciated in light of the disclosure, the order of operation within the method is not limited to the sequential execution as illustrated in FIG. 5, but may be performed in one or more varying orders as applicable and in accordance with the present disclosure. In various embodiments, the method 400 can be scheduled to run based on one or more predetermined events, and/or can run continuously during operation of the autonomous vehicle 10.

In various embodiments, the control method 400 can be implemented as a two stage process, where the first stage 402 determines keep clear zones 103 in upcoming lanes of a lane plan 94, and a second stage 404 determines whether stop points should be created based on the keep clear zones and expected travel of the vehicle 10 in the upcoming lanes.

For example, the method may begin in the first stage 402, where a lane plan 94 is received, and each lane of the lane plan is processed at 406-418. In particular, for each lane at 406, the lane location, lane features, or other information is looked up in the semantic map 104 at 408. If the semantic map defines the lane as a lane that should avoid stopping in at 410, then a keep clear zone is created at 412 and stored in a datastore at 414. If, however, the lane is not a lane that should avoid stopping in, then the method continues to process the next lane at 406. Once all of the lanes of the lane plan have been processed at 406, an empty list of stop points is created at 416 and stored at 418.

Thereafter, the method proceeds to the second stage 404, where each lane of the lane plan 94 is processed for a second time at 420-440. In particular, for each lane at 420, it is determined whether the lane is associated with a keep clear zone at 422. If the lane is not associated with a keep clear zone at 422, the method continues with processing the next lane at 420.

If, however, at 422 it is determined that the lane is associated with a keep clear zone, the vehicle speed 101 and the vehicle position 102 are queried and the future speed (Sf) and the future position (Pf) are determined based thereon at 424. Based on the future speed (Sf) and future position (Pf), it is determined whether a stop (and/or low speed) is expected in the associated keep clear zone (or at a particular position within the keep clear zone)at 426. For example, if the future position (Pf) is in the associated keep clear zone and the future speed (Sf) is less than a threshold speed (e.g., 2 m/s), then a stop (or slow speed) is expected. If a stop (or slow speed) is not expected, the method continues with processing the next lane at 420.

If, however, a stop (or slow speed) is expected at 426, then it is determined whether the current position is in the keep clear zone at 428. If the current position is in the keep clear zone, then no stop point is created and the method continues with processing the next lane at 420. If the current position is not in the associated keep clear zone at 428, it is determined whether the vehicle can “comfortably” stop at the beginning (or other location outside) of the keep clear zone at 430. If the vehicle cannot “comfortably” stop at the beginning of the keep clear zone at 430, the method continues with processing the next lane at 420.

If, however, it is determined that the vehicle can be “comfortably” stopped at the beginning (or other location outside) of the keep clear zone at 430, a boolean keep clear signal is created at 432. In various embodiments, a low pass filter and/or one or more hysteresis are applied to the keep clear signal at 434; and so long as the keep clear signal is active at 436, a stop point is maintained at the start point of the keep clear zone at 438. Thereafter, once all lanes have been processed at 420, the stop points are published as the advice to the path planner at 440 and the method continues with waiting for the next lane plan at 442.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of controlling a vehicle, comprising:
identifying, by a processor, at least one keep clear zone having a beginning and an ending within a roadway;
determining, by a processor, if a speed of the vehicle is expected to be below a threshold when a position of the vehicle is expected to be within the keep clear zone;
creating, by a processor, a stop point associated with the keep clear zone based on the determining;
generating, by a processor, advice to a path planner based on the stop point;
generating, by a processor, a path plan based on the stop point; and
controlling, by a processor, the vehicle based on the path plan.

2. The method of claim 1, further comprising associating a lane of an expected path plan with the keep clear zone, and wherein the creating the stop point is based on the lane of the expected path plan.

3. The method of claim 1, wherein the determining if the speed of the vehicle is expected to be below the threshold comprises determining if a future speed of the vehicle is expected to be below the threshold based on a current speed and current position of the vehicle.

4. The method of claim 1, wherein the determining if the position of the vehicle is expected to be within the keep clear zone comprises determining if a future position of the vehicle is expected to be within the keep clear zone based on a current position and a current speed of the vehicle.

5. The method of claim 1, wherein the creating the stop point is based on a location at the beginning of the keep clear zone.

6. The method of claim 1, further comprising determining if the vehicle can be stopped at a location outside of the keep clear zone, and wherein the creating the stop point is based on the location.

7. The method of claim 6, further comprising determining if the vehicle can be comfortably stopped at the location based on at least one of vehicle acceleration, vehicle deceleration, and vehicle jerk.

8. The method of claim 1, further comprising generating a boolean keep clear signal based on the determining, and wherein the creating the stop point is based on the boolean keep clear signal.

9. The method of claim 8, further comprising applying a low-pass filter to the boolean keep clear signal.

10. The method of claim 8, further comprising applying at least one hysteresis to the boolean keep clear signal.

11. The method of claim 1, wherein the generating the path plan is further based on object information, localization information, map information, and a desired vehicle route.

12. The method of claim 11, wherein the path plan is a path to be followed to maintain the vehicle on the desired route.

13. A system for controlling a vehicle, comprising:
a first non-transitory module configured to, by a processor, identify at least one keep clear zone having a beginning and an ending within a roadway;
a second non-transitory module configured to, by a processor, determine if a speed of the vehicle is expected to be below a threshold when a position of the vehicle is expected to be within the keep clear zone, and selectively create a stop point associated with the keep clear zone based on the determining; and
a third non-transitory module configured to, by a processor, generate advice to a path planner based on the stop point, wherein the vehicle is controlled based on the advice.

14. The system of claim 13, wherein the first non-transitory module is further configured to associate a lane of an expected path plan with the keep clear zone, and wherein the second non-transitory module is further configured to create the stop point based on the lane of the expected path plan.

15. The system of claim 13, wherein the second non-transitory module determines if the speed of the vehicle is expected to be below the threshold based on a current speed and current position of the vehicle and a future speed and a future position of the vehicle.

16. The system of claim 13, wherein the second non-transitory module determines if the position of the vehicle is expected to be within the keep clear zone based on a current speed and current position of the vehicle and a future speed and a future position of the vehicle.

17. The system of claim 13, wherein the second non-transitory module is further configure to determine if the vehicle can be stopped at a location outside of the keep clear zone, and creates the stop point based on the location.

18. The system of claim 17, wherein the second non-transitory module determines if the vehicle can be stopped based on at least one of vehicle acceleration, vehicle deceleration, and vehicle jerk.

19. The system of claim 13, wherein the second non-transitory module generates a Boolean keep clear signal based on the determining, and creates the stop point based on the Boolean keep clear signal.

20. The system of claim 19, wherein the second non-transitory module is further configured to apply at least one of a low-pass filter and at least one hysteresis to the boolean keep clear signal.
